(19) United States
(12) Patent Application Publication
(10) Pub. No.: US 2018/0229844 A1
(43) Pub. Date: Aug. 16, 2018

(54) INSTALLATION SYSTEM FOR AN AIRCRAFT

(71) Applicant: JET AVIATION AG, CH-4051 BASEL (CH)

(72) Inventors: Adam WHITE, Binningen (CH); Lionel NICOLAS, Ottmarsheim (CH); Loic NINI, Stetten (FR)

(73) Assignee: JET AVIATION AG, CH-4051 BASEL (CH)

(21) Appl. No.: 15/750,794

(22) PCT Filed: Jul. 20, 2016
(86) PCT No.: PCT/EP2016/067246

§ 371 Date: Feb. 6, 2018

Related U.S. Application Data
(63) Continuation of application No. 62/201,894, filed on Aug. 6, 2015.

(51) Int. Cl. B64D 11/00; B64C 1/40

(52) U.S. Cl. CPC B64D 11/00; B64C 1/406

(57) ABSTRACT

The invention is directed to an installation system (1) for installing at least one auxiliary device (2a-f) overhead and/or at a sidewall area in a fuselage (3) of an aircraft (4). The installation system includes at least one in principle two-dimensional carrier (5a, 5b, 5c, 5a′, 5b′, 5c′) with fastening points (6) and at least one tie rod (7) interconnected to a fastening point (6) and suited to be mechanically interconnected to a predefined fastening point (8) of the fuselage (3). The at least one auxiliary device (2) is attached to the carrier (5).

### BACKGROUND OF THE INVENTION

### Field of the Invention

The present invention is directed to an installation system for installing auxiliary devices in aircraft.

### Discussion of Related Art

Traditionally auxiliary devices, interior fittings and other components are attached directly to the fuselage of aircraft by means of so called brackets or tie rods.

US 2012/0298799 A1 was published on 29 Nov. 2012 on behalf of Airbus Operations GmbH and discloses a self-supporting cabin structural segment. US 2012/0298799 A1 is directed to the problem that an aircraft structure, respectively fuselage, is constantly subject to deformations, e.g. due to thermal deformations or flight mechanical loads. Such deformations also result in a change in the position of the cabin built-in elements, as these are usually fastened directly to the fuselage. Therefore, the disclosed cabin structural element is designed such that it can be fastened exclusively to the floor, such that all forces and/or moments acting on the cabin structural segment are introduced exclusively into the floor structure. Thus, all loads that occur in the passenger compartment are transferred to the floor, respectively the lower portion of the fuselage. This system leads to a significant stress concentration in the floor and consequently in the lower portion or the aircraft's fuselage, whereas the upper portion, in particular the crown region, is mostly unloaded.

US 2009/0026318 A1 was published on 29 Jan. 2009 on behalf of Airbus Deutschland GmbH and discloses an installation system for an airplane. This application is directed to the introduction of loads from system installations and cabin components into the primary structure of the fuselage, particularly into primary structures comprising carbon fiber reinforced plastics (CFRP). US 2009/0026318 A1 discloses an installation system for an aircraft for joining localized components situated transversely or longitudinally to the central axis of the aircraft. The installation system exhibits a first and second longitudinal rail and a first and second traverse. The longitudinal rails and traverses are joined to form an installation system, wherein the traverses are designed as peripheral rails to prepare the attachment of components along a periphery of the aircraft fuselage. System installations and cabin components can be installed by means of mounts that can be attached to the installation system built from the transverses and longitudinal rails.

U.S. Pat. No. 4,648,570 was published on Oct. 3, 1987 on behalf of The Boeing Company and shows a method and apparatus for supporting interior aircraft elements. It discloses a support structure for supporting interior passenger elements within an aircraft in order to convert an aircraft from a passenger configuration to a cargo configuration and vice versa. Therefore, the support structure comprises a plurality of longitudinal sections arranged end-to-end along a common longitudinal axis. To allow for expansion and deflection of the fuselage caused by pressurization of the aircraft and maneuver loads, an extension/retraction joint connects each such section and any adjacent section to allow axial slippage of each such section relative to the other sections. Furthermore, a plurality of diagonal struts is provided in order to transfer axial loads from the sections to the fuselage. In addition vertically oriented trusses are disclosed which on one side are connected to the fuselage and on the other side to the sections.

WO 2012/084204 A2 was published on 28 Jun. 2012 on behalf of Airbus Operations GmbH and discloses an aircraft system component carrier system which is directed to simplifying the mounting of an aircraft system component that is provided for disposing in the crown area of an aircraft. Therefore, a so-called aircraft system component carrier module, an aircraft system component which is fastened to the aircraft system component carrier module and an aircraft structural element of the fuselage are arranged such that they form an assembly group which is capable of being handled independently. In particular such an assembly group may be the crown area of an aircraft's fuselage and be connected in a final assembly step of the fuselage to the remaining parts (bottom shell and lateral areas of the fuselage). Thus during aircraft production, the initial installation of aircraft system components which extend along the fuselage (such as fluid and electric lines) can be simplified.

### SUMMARY OF THE INVENTION

In an aircraft usually a relatively high number of auxiliary devices which are not directly related to the actual flying of the aircraft are present. These typically include electronic/electric devices or components of the air conditioning, but may also embrace interior fittings, such as seats, bulkheads (separation walls), cabinets, lavatory units and others. Auxiliary devices are typically distributed over the whole inner side of an aircraft's fuselage. In many cases, relatively small components (e.g. antennae or power suppliers) are attached to the fuselage, usually by means of brackets which are fastened to customized fuselage connection points.

In order to identify a point or a direction in an aircraft's fuselage, within the context of the present invention an x/y/z Cartesian coordinate system is defined as follows: The x-axis extends laterally across the width of the aircraft. The y-axis extends longitudinally through the nose and the tail of the aircraft. The z-axis of the coordinate system extends vertically through the aircraft. In addition, hereinafter a direction parallel to the y-axis will also be referred to as “longitudinal direction”, whereas a direction parallel to the x-axis will also be referred to as “transversal direction” and a direction parallel to the z-axis will also be referred to as “vertical direction”.

Due to a number of reasons, aircraft usually have a relatively limited number of original fuselage connecting points, typically located at the frames (aka “formers”), the longerons or the intercostals. One reason for that is that in order to provide a fuselage connecting point, usually the fuselage has to be drilled, which leads to a mechanical weakening of the fuselage. Consequently, the structure surrounding such bores has to be reinforced, which in general is labor-intensive and adds weight to the aircraft. These are some of the reasons why most aircraft only comprise a relatively low number of original fuselage connecting points which are typically designed for standard airline aircraft that have a standard interior design and equipment. As such, the original fuselage connecting points may be provided for fastening e.g. overhead lockers, ceiling, floor and few larger standard modules (such as lavatory units, galley units or crew rest units) at standard positions within the passengers compartment. Consequently, if additional auxiliary devices and/or customized interior fittings have to be installed in such aircraft, additional custom connecting points may have to be introduced in the fuselage.

In conventional aircraft this is usually done by drilling holes in frames, longerons or intercostals made from aluminum, which subsequently can serve as additional connecting points for brackets or tie rods. However doing such drilling operation in aircraft is relatively complicated as it requires special precaution to prevent contamination by drilling chips and cutting fluids. Hence establishing such additional connection points is relatively labor-intensive and time consuming.

Furthermore, in recent years new types of materials, in particular composite materials, have emerged in aircraft construction. Examples for this development are Boeing's 787 and Airbus' A350, whose fuselages are made primarily of carbon fiber reinforced plastics. In such aircraft, introduction of additional/customized fuselage connection points often turns out to be particularly critical. On the one hand the number of original (predefined) fuselage connection points in such aircraft is still very low as establishing them when the fuselage is originally built up from fibers and resin requires a lot of manual work. Consequently, even more than for conventional aircraft, aircraft manufacturers keep the number of fuselage connection points to a minimum. On the other hand establishing additional (customized) fuselage connection points in such types of fuselages turns out to be highly critical or even impossible because bores drilled in fiber reinforced plastics typically causes a significant reduction of the fuselage's mechanical competence. Consequently one will always try to avoid drilling operations in fuselages made from composite materials.

In addition, each substantial physical change in the fuselage's structure has an influence on its structural competence, respectively integrity. Therefore, the consequences of such additional fuselage connecting points must be determined, respectively their permissibility must be simulated. In order to be able to do the required calculations/simulations, the position of all existing and planned fuselage connecting points has to be known precisely. In particular for wide-body aircraft, but also for narrow-body aircraft, whose fuselages may have a diameter of more than 7 meters and a length of more than 70 meters, these positions may vary significantly between aircraft of the same type due to fabrication tolerances. The same holds true for refurbishing of aircraft, where the position of the original connecting points may be unknown and also already a number of additional fuselage connecting points may be present. Therefore, in many cases the position of the existing fuselage connecting points has to be determined by extensive measurements, such as e.g. laser scanning.

Consequently, refurbishing and/or completion of aircraft often turns out to be labor-intensive and time-consuming work which cannot be started before an aircraft is accessible and cleared from interior components for inspection and scanning work. Not till then, the detailed planning and simulation of refurbishing or completion work can begin. This significantly increases the time needed for refurbishing/completion and consequently increases also the expensive immobilization time of an aircraft.

It is therefore one object of the present invention to provide an installation system for one or several auxiliary devices which allows to improve planning and execution of refurbishing and/or completion work in aircraft easily and in a flexible manner.

According to the invention, an installation system for installing at least one auxiliary device overhead (in the crown area) and/or at a sidewall area in a fuselage of an aircraft usually comprises at least one in principle two-dimensional carrier with fastening points. An in principle two-dimensional carrier may also be curved, following at least partially the contour of the fuselage, as will be explained in further detail below. As well, the installation system usually comprises at least one tie rod which is interconnected to a fastening point (connecting point) and suited to be mechanically interconnected to a predefined fastening point (connecting point) of the fuselage. Such predefined fastening points may be original fuselage connecting points of an aircraft but may also be custom-made connecting points. The invention is not limited to conventional tie rods and alternatively or in addition also other types of connectors, including direct connections (e.g. bolted and/or screwed joints) may be applied. According to the invention at least one auxiliary device is attached to the carrier.

Good results may be obtained if the at least one carrier is arranged at a distance from the fuselage of the aircraft forming engineering space for the arrangement of the at least one auxiliary device.

Depending on the position in the fuselage where the auxiliary device has to be installed, the carrier may be spatially curved in at least one direction. Such types of spatially curved carriers may e.g. be installed in a certain distance from the fuselage crown area, such as at the sidewall areas of the fuselage, as will be shown in further details below. Alternatively or in addition the carrier may also comprise a recess where at least one auxiliary device may be arranged.

Alternatively or in addition at least one interior fitting may be supported by at least one carrier in longitudinal and/or transversal and/or vertical direction of the fuselage of the aircraft. Hence, the installation system may e.g. be used in order to attach different components that belong to interior design of the passenger compartment to the fuselage.

Immobilization time of an aircraft for refurbishing or completion may be significantly reduced if at least one preassembled unit comprising a carrier and at least one auxiliary device and/or interior fitting is assembled outside of an aircraft. Thus e.g. (sub-) systems with multiple auxiliary devices, which may be interconnected with each other in a complex manner, may be assembled, validated and verified prior to bringing them into the aircraft. In addition, overhead work inside of the aircraft can be minimized because outside of the aircraft a carrier can be brought in an ergonomically favorable working position, allowing auxiliary devices being mounted in an ergonomically optimized way. As well such preassembly outside of an aircraft makes it possible that multiple technicians can work on the same system at the same time which is usually not possible inside of an aircraft due to the limited accessibility of the installation space.

In particular, refurbishing and/or completion work may significantly be reduced if cabinets, bulkheads, lavatory units, galley units, crew rest units are supported by at least one carrier according to the invention.

Particularly heavy or large-dimension interior fittings may also be supported by multiple carriers. These carriers may be arranged in longitudinal and/or transversal direction of the fuselage.

For some applications a panel may be attached to the carrier or may form part of the carrier such that it provides an internal surface of the aircraft. Such an internal surface may e.g. be part of a ceiling or a cabin wall.

In order to reduce noise in a passenger compartment, the carrier may comprise a soundproofing element or may form part of a soundproofing system, as will be explained in further detail below. Good reduction of noise may be obtained if a soundproofing blanket is attached to the carrier on the side which is directed to the fuselage and/or the side which is directed to the passenger compartment, forming a space between the carrier and the fuselage to absorb sound. Such a soundproofing blanket may comprise a first layer made from a foil material and a second layer that is made from a foam material.

Alternatively or in addition, in order to reduce vibration and/or noise, the at least one tie rod may comprise a vibration-damping part, such as an elastic or viscoelastic portion which reduces propagation of vibrations between the fuselage and the carrier. Such an elastic or viscoelastic portion may e.g. be a sleeve made from an elastic or viscoelastic material.

An installation system with a high mechanical competence, low additional weight and high versatility may be obtained if the carrier comprises a frame, as will be explained in further detail below. Good results may be obtained if the frame comprises, with respect to the longitudinal direction (y) of the fuselage, at least two longitudinal beams and at least two transversal beams interconnected to each other forming an outer limitation of the carrier. Such a type of carrier offers high torsional rigidity as well as relatively high number of fastening points. Furthermore, it may form or be part of a grid which divides the space in an aircraft in a steady (well-known) manner, which simplifies planning and/or installation of auxiliary devices and systems.

In order to obtain a carrier with a particularly high stiffness and strength, at least one longitudinal and one transversal beam may be mechanically interconnected by means of a cap, as will be explained in further detail below.

A very user-friendly installation of an auxiliary device may be obtained if the carrier comprises a frame that has an essentially rectangular shape.

A particularly high mechanical competence may be obtained if the longitudinal and/or transversal beams are made by extrusion molding. However, the longitudinal and/or transversal beams may also comprise at least one portion which is machined. Such a variation may be used in order to obtain spatially curved carriers, as will be shown in further detail below.

An installation system with a high number of interfaces where an auxiliary device may be attached may be obtained if at least one of the longitudinal and/or transversal beams is a C-beam (aka “U-beam”), as will be explained in further detail below.

An installation system that can be used for narrow-body as well as wide-body aircraft and which is suited to bear a large variety of auxiliary devices while still being lightweight may be obtained if the longitudinal and/or transversal beams is a C-beam with a height (length of the web) of about 50 mm, a width (length of the flanges) of about 20 mm and a web thickness as well as flange thickness of about 2 mm. Hence using such a variation of a beam allows establishing carriers for virtually all types of aircraft. Consequently logistics can be simplified and inventory cost be decreased.

A high number of attachment points for auxiliary devices provided at many different positions of the carrier, as well as a relatively low total weight, while still having a high structural competence, may be obtained if the longitudinal and/or transversal beams is a C-beam which comprises multiple bores that are arranged at an even pitch in its web. Good results may be obtained if the bores are arranged at a pitch of about 1 inch (25.4 mm) in beam-length direction and of about 25/32 inches (20 mm) in direction of the beam height.

An installation system with a low total weight may be obtained if the longitudinal and/or transversal beams are made from a material chosen from the group consisting of aluminum, titanium, fiber reinforced plastics. For some application, the longitudinal and/or transversal beams may also be made from steel. Within the context of the present invention, “aluminum” and “titanium” should be understood as meaning also their alloys.

In a variation of the invention, the fastening points for the tie rods (or other types of mechanical connectors) are at least partially arranged at the frame, such that relatively large auxiliary devices can be attached safely to the fuselage. In addition, this way the bending moments induced by an auxiliary device and/or interior fitting acting on a carrier can be minimized.

If appropriate, the transversal beams may be at least partially curved. Thus curved carriers may be obtained.

For some purposes, an installation system may comprise at least one connector to interconnect a first carrier to a second carrier in longitudinal and/or transversal direction. Thus multiple carriers may be mechanically interconnected with each other, forming an installation system that may have a grid layout.

In a variation of a carrier according to the invention, at least one connector may be part of a fastening point of the installation system, respectively the fastening point may be part of a connector

For some purposes the carrier may be or may comprise a plate-like or a shell-like structure. Thus a carrier with a high mechanical competence, in particular a high stiffness, and low weight may be obtained. As well, such a carrier may serve as a ceiling and/or cabin wall (sidewall) element. Good results may be obtained if the carrier is a plate-like or shell-like structure which is at least partially made from a composite material, such as a carbon fibers reinforced plastic. Alternatively or in addition also other types of fibers, such as aramide or glass fibers may be used.

In order to obtain electrical bonding between multiple carriers and/or multiple auxiliary devices and/or multiple interior fittings, multiple carriers of an installation system may also be interconnected electrically by one or multiple electrical connectors or a drain wire. An installation system with such electrical bonding may e.g. be advantageous if used in aircraft whose fuselage is at least partially made from a composite material. For some applications, respectively auxiliary devices, also means for electromagnetic shielding may be attached to a carrier.

If required, an installation system may comprise several carriers which are interconnected by a connector that comprises means to compensate shift between the individual carriers in longitudinal and/or transversal direction. Consequently relative displacements between the fuselage and one or multiple carriers due to thermal expansion of the fuselage or the carriers or due to flight mechanical loads can be compensated. Such means to compensate shift may comprise special types of bearings and/or materials (e.g. elastic materials), as will be explained in further detail below.

The space available for passengers may be maximized, if the at least one tie rod and the at least one auxiliary device are arranged on the same side of the carrier.

Aircraft refurbishment and completion may be significantly accelerated if the installation system is used in order to preinstall an auxiliary device (or multiple) out of the group of the following devices outside of the aircraft: Tubing, wiring, air outlet/diffuser, air inlet, air duct, recirculation fan, electronic device, electric device, power distribution unit configured to supply electric power to at least one consumer, central controller unit in order to monitor and/or control functioning of a power distribution unit.

For some purposes the at least one auxiliary device and/or an interior fitting may be attached to the carrier by means of a bracket.

A particularly easy and fast setup of an installation system in an aircraft is possible if the carrier and the at least one auxiliary device form a preassembled unit.

Preferably a carrier, respectively a preassembled unit, is dimensioned such that it can be brought into the inner of an aircraft's fuselage through a cargo door or a passenger door without the need of being disassembled before.

An installation system with a particularly good mechanical competence can be obtained if several carriers form a grid or are part of a grid, as will be explained in further detail below.

An installation system which is particularly easy to install inside the fuselage of an aircraft and at the same time comprises a high versatility may be obtained if the outer dimension of the carrier in longitudinal direction (y-direction) is essentially equal to the distance between two adjacent frames of the aircraft's fuselage (aka “frame pitch”). Such a variation of an installation system may also be used in order to fasten a particularly high number of auxiliary devices to the fuselage, as well as to bear particularly high loads and to compensate for large shifts in the longitudinal direction of the fuselage of the aircraft. The dimension in longitudinal direction (y-direction) may e.g. be the outer dimension of a frame in longitudinal direction or may also be the distance in longitudinal direction (y-direction) between two fastening points of the carrier which are to be mechanically interconnected to two predefined fastening points of the fuselage.

Good results may be obtained if the carrier's dimension in longitudinal direction (y-direction) is between about 18 inches (457.2 mm) and about 26 inches (660.4 mm). A carrier that can be used for a first large group of different aircraft types may have a dimension in longitudinal direction (y-direction) of about 20 inches (508 mm). A second variation of a carrier that may be used for another large group of different aircraft types may have a dimension in longitudinal direction (y-direction) of about 21 inches (533.4 mm). However, for special types of aircraft, the carrier may have a dimension in longitudinal direction (y-direction) of about 24 inches (609.6 mm) or of 25 inches (635 mm).

For some purposes, a carrier may also have a dimension in the longitudinal direction which essentially is a multiple N (N=2, 3, 4 . . . ) of the frame pitch P of the fuselage of the aircraft. Hence, in such a variation of the invention, the dimension of the carrier in the longitudinal direction (y-direction) may essentially be e.g. 2·P, 3·P or 4·P. Such a variation of an installation system may e.g. be used in order to establish preassembled units comprising auxiliary devices whose dimension in longitudinal direction in the mounted state is higher than the frame pitch of the aircraft's fuselage.

For some purposes, an installation system may also comprise multiple carriers whose dimensions in longitudinal direction (y-direction) differ from each other and that form a grid or are part of a grid.

Compatibility with a large number of different auxiliary devices may be obtained with a carrier that comprises multiple bores configured to serve as attachment points for an auxiliary device and/or an interior fitting.

If required a mock-up of a fuselage of a specified aircraft for an installation system is provided, wherein the mock-up comprises predefined (original) fastening points of the fuselage of the specified aircraft. Such a mock-up may be made from wood. Thanks to such a mock-up in combination with an installation system according to the present invention, it becomes possible to preassemble, validate, verify and optimize even highly complex systems of cabin interior systems before these systems are moved into the aircraft's cabin.

Very efficient preassembly may become possible if the mock-up comprises frames with a frame pitch that is equal to the frame pitch of the fuselage of a specified aircraft the installation system has to be installed in.

### BRIEF DESCRIPTION OF SEVERAL VIEWS OF THE DRAWINGS

The herein described invention will be more fully understood from the description of the given herein below and the accompanying drawings, which should not be considered as limiting to the invention described in the appended claims.

FIG. 1 schematically shows an aircraft with an installation system according to the present invention in a perspective view, the fuselage of the aircraft being partially clipped for illustrative purposes;

FIG. 2 shows detail A of FIG. 1;

FIG. 3 schematically shows the alignment of an installation system in an aircraft in a top view;

FIG. 4 schematically shows cross section BB of FIG. 3;

FIG. 5 schematically shows a first variation of a carrier according to the invention in a perspective view;

FIG. 6 schematically shows a second variation of a carrier according to the invention in a perspective view;

FIG. 7 schematically shows an installation system comprising a grid built from multiple carriers in a perspective view;

FIG. 8 shows detail C of FIG. 7;

FIG. 9 schematically shows an installation system comprising multiple carriers and auxiliary devices in a perspective view.

### DETAILED DESCRIPTION OF THE INVENTION

The foregoing summary, as well as the following detailed description of the preferred embodiments, is better understood when read in conjunction with the appended drawings. For the purpose of illustrating the invention, an embodiment that is presently preferred, in which like reference numerals represent similar parts throughout the several views of the drawings, it being understood, however, that the invention is not limited to the specific methods and instrumentalities disclosed.

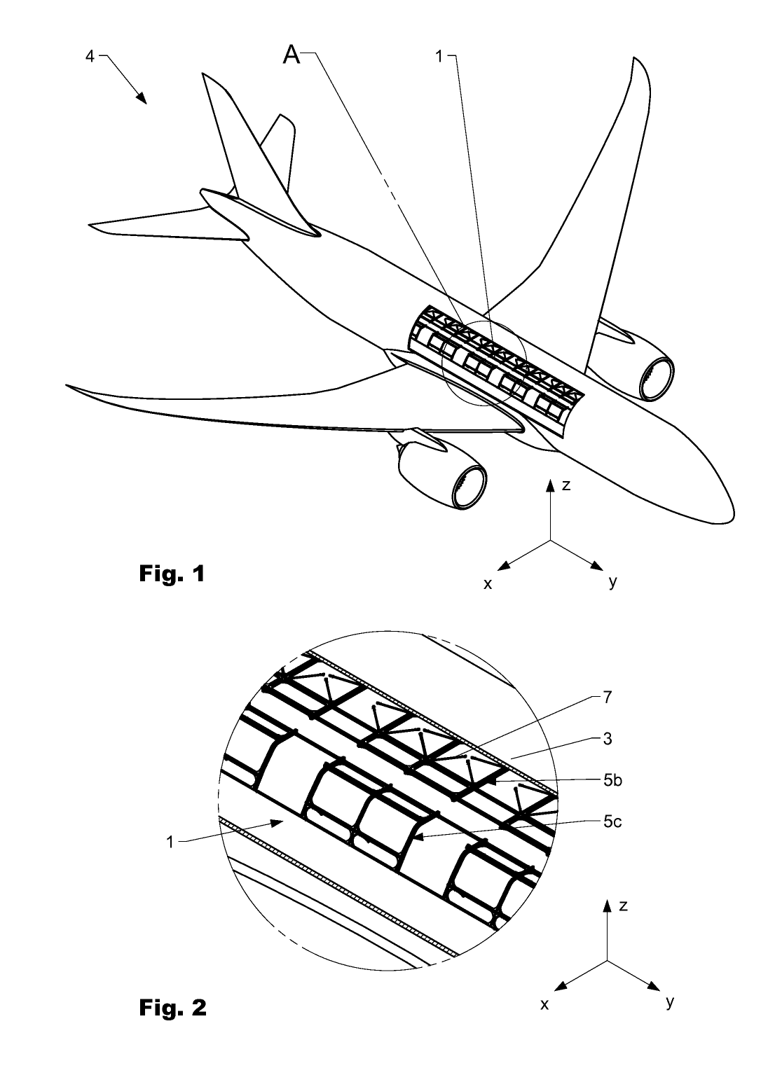

FIGS. 1 and 2 schematically show an aircraft 4 with an installation system 1 according to the invention, which comprises multiple carriers 5b, 5c (for illustrative purposes not all carriers have reference numerals) that are interconnected with the crown area and/or the sidewall area of the fuselage 3 by means of tie rods 7. Although the installation system 1 shown in FIGS. 1 and 2 is installed in a wide-body aircraft 4, an installation system 1 according to the invention in general can also be used for narrow-body aircraft. It is also not limited to airplanes, but may also be used for other types of aircraft, such as helicopters or airships.

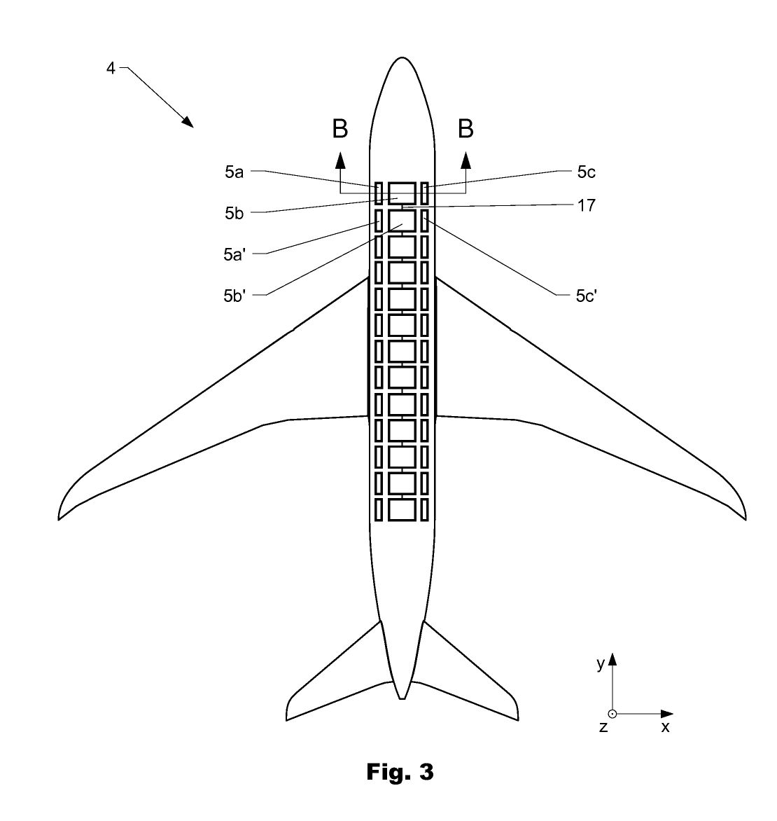

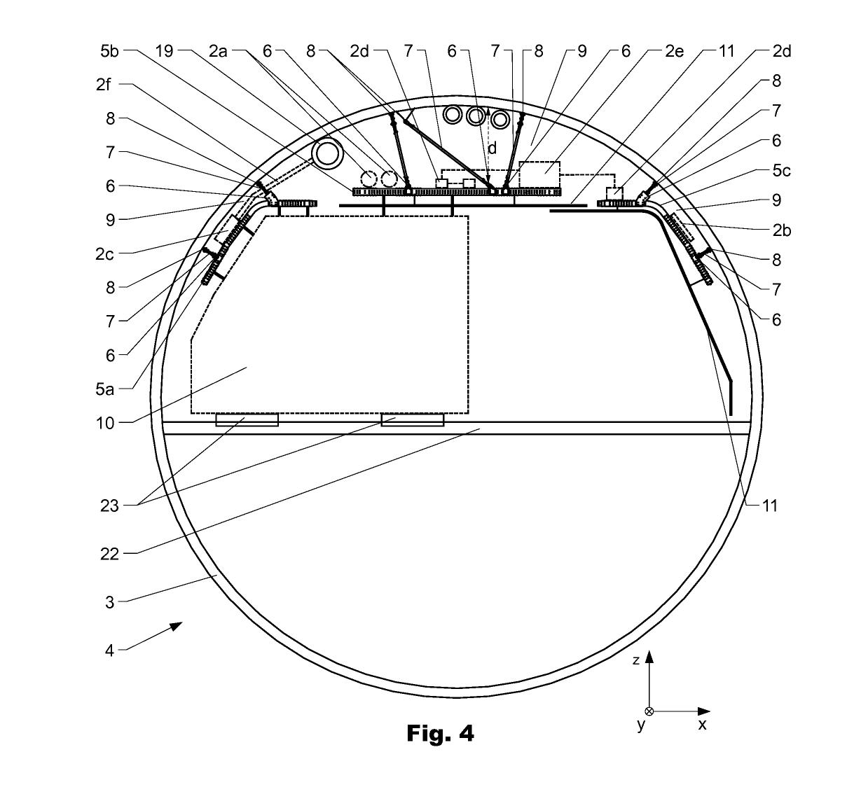

As schematically shown in FIG. 3, the installation system 1 may form one or several grid(s) which extend(s) in longitudinal direction (y-axis) as well as in transversal direction (x-axis) of the aircraft 4. In the embodiment shown, three different types of carriers 5a, 5b, 5c, 5a′, 5b′, 5c′ are used. In the middle section of the fuselage's 3 crown area, a first type of an essentially flat carrier 5b, 5b′ is arranged, whereas in x-direction adjacent to it two curved carriers 5a, 5a′, 5c, 5c′ are arranged at the sidewall area, as will be explained in further detail in FIG. 4. In the variation of an installation system 1 shown in FIG. 3, the carriers 5b, 5b′ arranged in the crown area of the fuselage 3 are mechanically interconnected by connectors 17.

FIG. 4 schematically shows a cross section BB of FIG. 3. As can be seen, the installation system 1 comprises a flat carrier 5b arranged overhead in the middle of the crown area. Carrier 5b comprises several fastening points 6 which are mechanically interconnected with original fastening (connecting) points 8 of the fuselage 3 by means of tie rods 7. The fastening points 6 of the carrier 5b and tie rods 7 are arranged such that loads introduced in the carrier 5b in x-, y- and z-direction can be transferred from the carrier 5b to the fuselage 3. Hence, the carrier 5b is mechanically rigidly interconnected with the fuselage 3. In transversal direction (x-axis) adjacent to the flat carrier 5b, curved (lateral) carriers 5a, 5c are arranged at the sidewall area of the fuselage 3, the curved carriers 5a, 5c being connected with the fuselage 3 by means of tie rods 7 in a similar manner as the middle carrier 5b. The carrier 5b is arranged in a certain distance d from the fuselage, defining engineering space 9 between the fuselage and the carrier 5b where different (multiple) auxiliary devices 2a-f are arranged. The same holds true for the other carriers 5a, 5c. The auxiliary devices include a power distribution unit 2e which is fastened to the top side of the flat carrier 5b. The power distribution unit 2e is electrically interconnected by wiring with several consumers, which may be electric or electronic devices 2d that may e.g. comprise lighting devices or antennae. As schematically shown, these auxiliary devices 2a-f may be arranged on the same carrier 5b or on different carriers 5a, 5c. However, some auxiliary devices may still be attached directly to the fuselage 3. As well, other components, such as e.g. tubing 2a for fresh water may be fastened to the carriers 5a, 5b, 5c. As shown in FIG. 4, also components of an air conditioning system may be attached to the carriers 5a, 5b, 5c. In the embodiment shown in FIG. 4, an air outlet 2c and a small air duct 2f which are part of the passenger compartment distribution system are attached to a lateral carrier 5a, the small air duct 2f being fluidically connected to a main air duct 19 that extends in longitudinal direction through the passenger compartment and which is attached directly to the fuselage 3. As well, wiring 2b may be attached to a carrier 5c. If desired, a high number of such auxiliary devices 2a-f may be attached to the carriers 5a, 5b, 5c before they are brought inside the aircraft 4. Such preassembled units can be used in order to reduce labor and time consuming installation work inside the aircraft 4. Hence virtually all auxiliary devices 2a-f may be attached to the fuselage 3 by simply connecting the carriers 5a, 5b, 5c to the predefined/existing fuselage 3 connecting/fastening points 8 by means of a relatively low number of tie rods 7. By this, also the number of tie rods 7 as well as brackets can be reduced, which fully or at least partially compensates for the additional weight of the carriers 5a, 5b, 5c.

As also shown in FIG. 4, an interior fitting 10 is mechanically connected to the carriers 5a, 5b of the installation system 1. The interior fitting 10 shown may be a cabinet. Typically, most of an interior fitting's 10 weight will be transferred by floor fittings 23 to the floor 22 and from there to the fuselage 3 whereas the carriers 5a, 5b will support the interior fitting 10 in longitudinal direction (y-direction) and transversal direction (x-direction) of the fuselage 3 of the aircraft 4. However, some types of interior fittings 10 may also be supported in z-direction by the carriers 5a, 5b, 5c. As shown, also panels 11 may be connected to the carriers 5b, 5c and form internal surfaces of the ceiling and cabinet wall of the passenger component. As can also be seen, not all auxiliary devices 2a-f or interior fittings 10 have to be interconnected with the carriers 5a, 5b, 5c of the installation system 1 and some components may still be directly fastened to the fuselage 3.

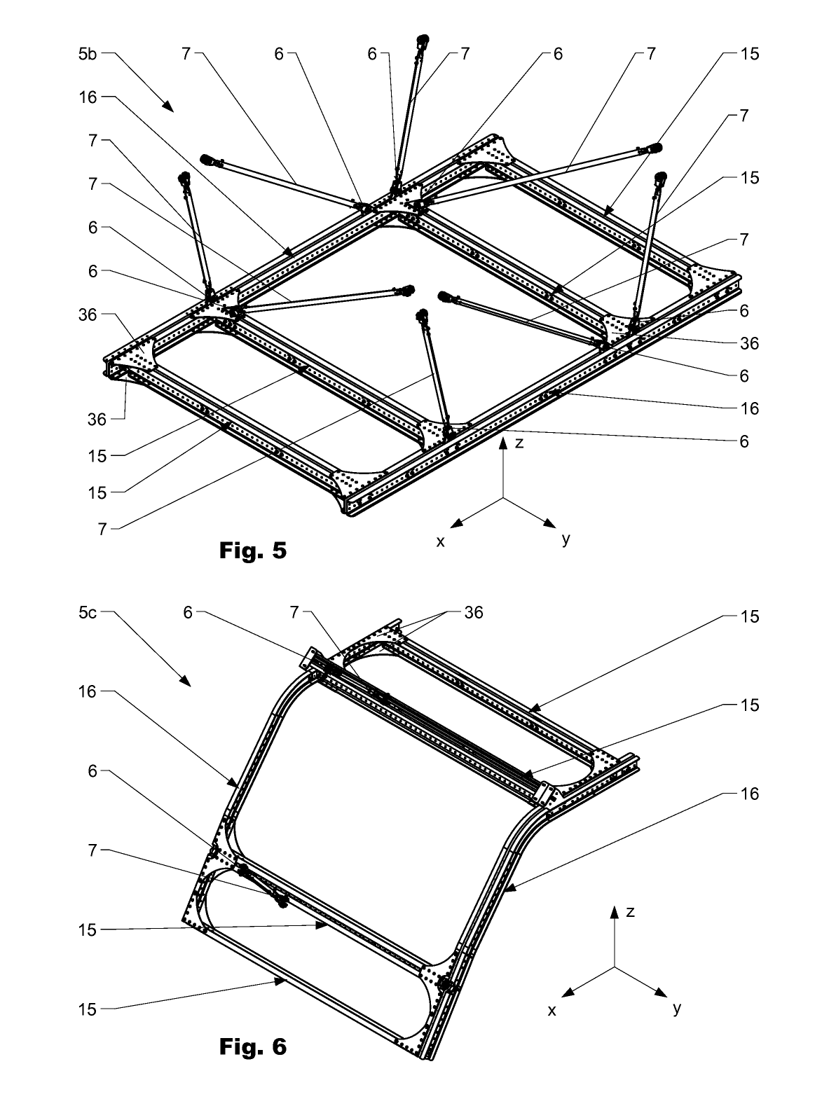

FIG. 5 shows a flat carrier 5b of a variation of the installation system 1 according to the invention. The carrier 5b comprises four longitudinal beams 15 which are mechanically interconnected by means of two transversal beams 16. The longitudinal and transversal beams 15, 16 each are made from two C-beams, as will be shown in further detail in FIG. 8. The longitudinal and transversal beams 15, 16 are arranged such that they form a frame-like structure. Due to the C-beams and the frame-like structure, the carrier 5b comprises a relatively high torsional rigidity. The carrier 5b comprises eight fastening points 6. At each fastening point 6 a tie rod 7 is attached. In order to increase stiffness and strength of the carrier 5, the longitudinal and transversal beams 15, 16 are mechanically interconnected by means of plate-like caps 27, which will be shown in further detail in FIG. 8.

FIG. 6 shows a curved carrier 5c which is also made from four longitudinal beams 15 and two transversal beams 16. In the variation shown, the transversal beams 16 comprise a curved portion. The curved portions shown are made by machining, whereas the straight portions of the beams 16 may be made by extrusion molding. The carrier 5c may also be connected to the fuselage 3 of an aircraft by means of tie rods 7.

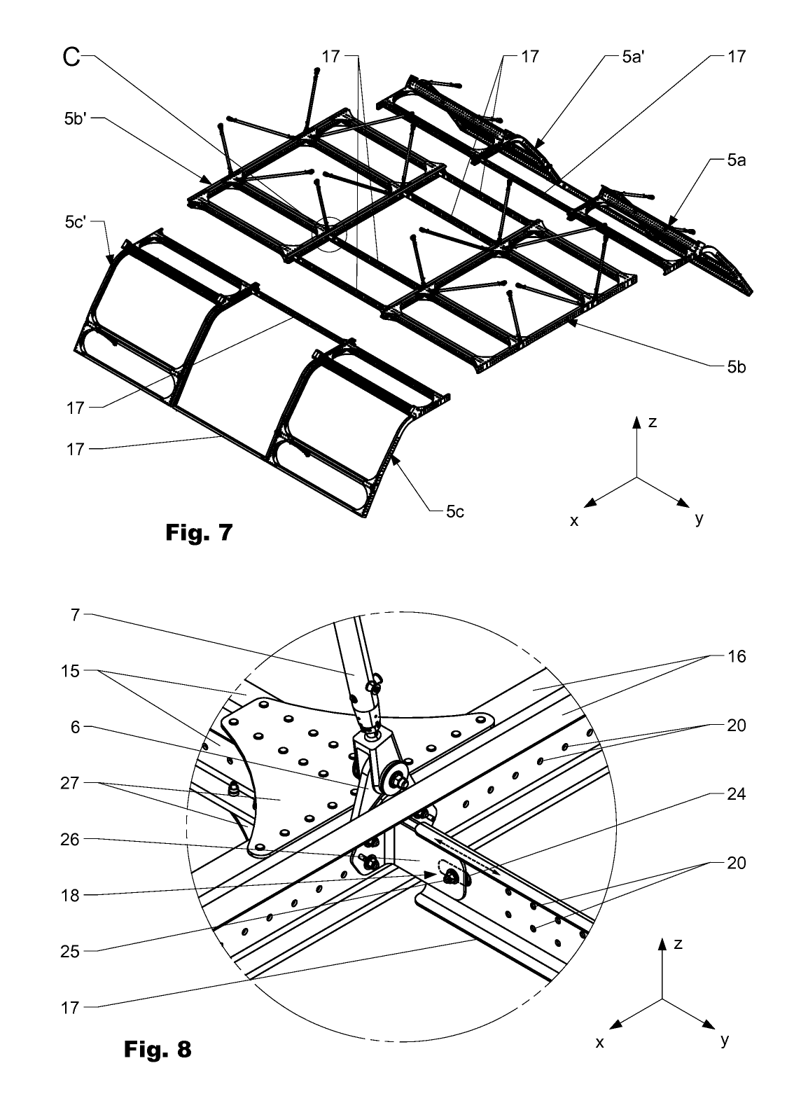

As shown in FIG. 7, multiple carriers 5a, 5a′, 5b, 5b′, 5c, 5c′ may be at least partially interconnected in order to build a grid. In the embodiment shown, carriers that are adjacent in longitudinal direction of the fuselage 3 are interconnected to each other by means of connectors 17, which in the variation shown are beams. In order to compensate shift in longitudinal direction (y-axis) of the fuselage 3, e.g. due to thermal expansion, the grid comprises compensator means 18, as shown in detail in FIG. 8. As can be seen, the connectors 17 are made from two C-beams which at their end region have an elongated hole 24 (indicated by a dotted line). On the transversal beam 16 a holder 26 is arranged. The holder 26 is made from two angled portions arranged at a certain distance from each other, forming a slot in which the connector 17 is arranged. A bearing screw 25 is fastened to holder 35 and arranged in the elongated hole 24 which allows relative displacements (indicated by the dotted arrow) between the transversal beam 16 (respectively the carrier 5b′) and the connector 17 (respectively the carrier 5b). Alternatively or in addition a connector 17 may also comprise a compensator means 18 made at least partially from an elastic material which is able to deform non-destructively in order to compensate shift in longitudinal direction of the fuselage. Such a connector may e.g. be a pin connection where the pin is supported in a bushing made from an elastic material. As can also be seen, the beams 15, 16 and the connector 17 comprise multiple bores 20 (respectively holes) which are arranged at an even pitch. These bores 20 help to decrease total weight of the installation system 1, as well as they can serve as fastening points 6 for tie rods 7 or to attach auxiliary devices 2a-f (not shown) to the carriers 5a, 5b, 5c and/or to the connectors 17. Auxiliary devices 2a-f and/or brackets may be fastened directly to the beams, or by means of connecting means, as shown in FIG. 8. As shown, the longitudinal and transversal beams 15, 16 are mechanically interconnected by means of caps 27 which are fastened to the flanges of the beams. As shown in FIG. 8 the caps 27 and beams 15, 16 may be mechanically interconnected by screwed connections. However, the present invention is not limited to this type of connection and also e.g. rivet connections and/or welding may be applied.

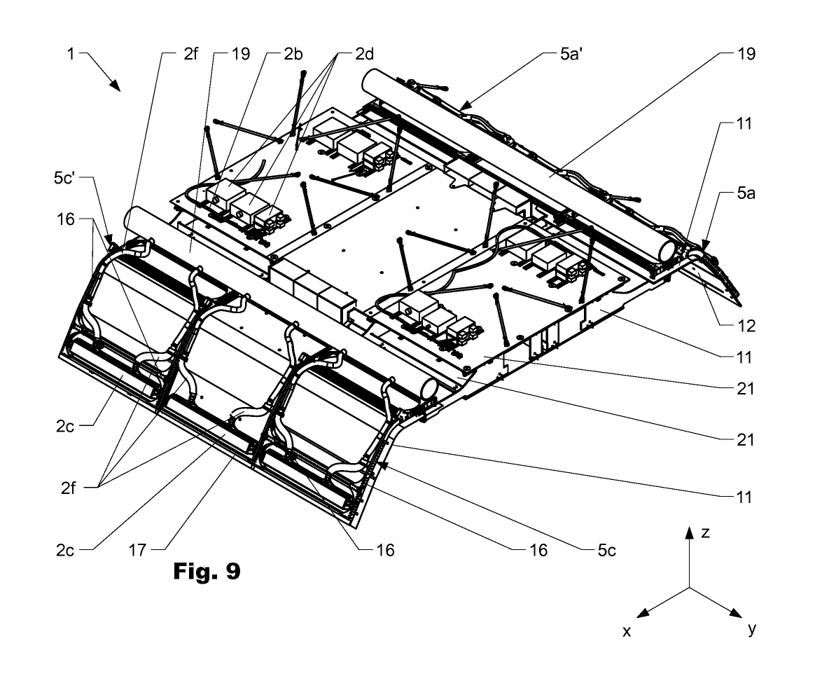

FIG. 9 shows a variation of an installation system 1 according to the invention with multiple auxiliary devices 2a-f as well as interior fittings 11 installed to the grid as shown in FIG. 7. The installation system 1 comprises components of the air conditioning system, such as multiple air outlets 2c which are connected to the carriers 5c, 5c′ as well as to the connectors 17. The air outlets 2c are fluidically interconnected with the main air ducts 19 by means of small air ducts 2f which are mechanically interconnected to the transversal beams 16 of the carriers 5c, 5c′. As well, multiple electronic and/or electric devices 2d are attached to the installation system 1 and interconnected by wiring 2b.

As can also be seen, a soundproofing blanket 21 is attached to the carriers in order to reduce noise level in the passenger compartment and hence together with other components is part of a soundproofing system. Due to the engineering space between the carriers 5a, 5b, 5c and the fuselage (not shown), soundproofing can be significantly improved. As well, panels 11 are attached to the carriers 5a, 5b, 5c, 5a′, 5b′, 5c′ and provide an internal surface 12 which is part of the passenger compartment's ceiling.

1. An installation system (1) for installing at least one auxiliary device (2a-f) overhead and/or at a sidewall area in a fuselage (3) of an aircraft (4), comprising
a. at least one in principle two-dimensional carrier (5a, 5b, 5c, 5a′, 5b′, 5c′) with fastening points (6) and
b. at least one tie rod (7) interconnected to a fastening point (6) and adapted to be mechanically interconnected to a predefined fastening point (8) of the fuselage (3); wherein
c. the at least one auxiliary device (2a-f) is attached to the carrier (5).

2. The installation system (1) according to claim 1, wherein the at least one carrier (5a, 5b, 5c, 5a′, 5b′, 5c′) is arranged at a distance (d) from the fuselage (3) of the aircraft (4) forming engineering space (9) for the arrangement of the at least one auxiliary device (2).

3. The installation system (1) according to claim 1, wherein the carrier (5a, 5c, 5a′, 5c′) is in at least one direction spatially curved.

4. The installation system (1) according to claim 1, wherein at least one interior fitting (10) is supported by at least one carrier (5a, 5b, 5c, 5a′, 5b′, 5c′) in a longitudinal direction (y) of the fuselage (3) of the aircraft (4).

5. The installation system (1) according to claim 4, wherein the at least one interior fitting (10) is selected from the group of: Cabinet, bulkhead, lavatory unit, galley unit, and crew rest unit.

6. The installation system (1) according to claim 1, wherein a panel (11) is attached to the carrier (5a, 5b, 5c, 5a′, 5b′, 5c′) or is forming part of the carrier (5a, 5b, 5c, 5a′, 5b′, 5c′) providing an internal surface (12) of the aircraft (4).

7. The installation system (1) according to claim 1, wherein the carrier (5a, 5b, 5c, 5a′, 5b′, 5c′) comprises a soundproofing element (13) or is forming part of a soundproofing system.

8. The installation system (1) according to claim 1, wherein the carrier (5a, 5b, 5c, 5a′, 5b′, 5c′) comprises a frame (14).

9. The installation system (1) according to claim 8, wherein the frame (14) comprises, with respect to a longitudinal direction (y) of the fuselage (3), at least two longitudinal beams (15) and at least two transversal beams (16) interconnected to each other forming an outer limitation of the carrier (5).

10. The installation system (1) according to claim 8, wherein the fastening points (6) for the tie rods (7) are at least partially arranged at the frame (14).

11. The installation system (1) according to claim 9, wherein the transversal beams (16) are at least partially curved.

12. The installation system (1) according to claim 1, wherein the installation system (1) comprises at least one connector (17) to interconnect a first carrier (5a, 5b, 5c) to a second carrier (5a′, 5b′, 5c′) in longitudinal (y) and/or transversal direction (x).

13. The installation system (1) according to claim 12, wherein the connector (17) comprises a means (18) to compensate shift in longitudinal (y) and/or transversal direction (x).

14. The installation system (1) according to claim 1, wherein the at least one tie rod (7) and the at least one auxiliary device (2a-f) are arranged on the same side of the carrier (5a, 5b, 5c, 5a′, 5b′, 5c′).

15. The installation system (1) according to claim 1, wherein the at least one auxiliary device (2a-f) is selected from the group of: Tubing (2a), wiring (2b), air outlet/diffuser (2c), air inlet, air duct (2f), recirculation fan, electronic device (2d), electric device (2d), power distribution unit (2e) configured to supply electric power to at least one consumer (2d), central controller unit in order to monitor and/or control functioning of a power distribution unit (2e).

16. The installation system (1) according to claim 1, wherein the carrier (5) and the at least one auxiliary device (2a-f) form a preassembled unit.

17. The installation system (1) according to claim 1, wherein several carriers (5a, 5b, 5c, 5a′, 5b′, 5c′) form a grid or are part of a grid.

18. Mock-up of a fuselage (3) of a specified aircraft (4) for an installation system (1) according to claim 1, wherein the mock-up comprises predefined fastening points (8) of the fuselage (3) of the specified aircraft (4).
